(19) United States
(12) Patent Application Publication
(10) Pub. No.: US 2013/0325552 A1
(43) Pub. Date: Dec. 5, 2013

(54) Initiating Root Cause Analysis, Systems And Methods

(71) Applicant: Razieh Niazi, New York (CA)

(72) Inventor: Razieh Niazi, New York (CA)

(21) Appl. No.: 13/907,316

(22) Filed: May 31, 2013

Related U.S. Application Data
(60) Provisional application No. 61/653,641, filed on May 31, 2012.
(60) Provisional application No. 61/661,014, filed on Jun. 18, 2012.

(51) Int. Cl. G06Q 30/02

(52) U.S. Cl. CPC G06Q 30/0203
USPC 705/7.32

(57) ABSTRACT

Method of generating root causes for sentiments is presented. An individual can initial a root cause analysis of a corpus of documents (e.g., product reviews), possibly through clicking an icon near the corpus. A root cause analysis engine analyzes the corpus and sentiment to generate one or more root causes for the sentiment. The engine can then configure an output device to present the root causes for further review. The services offered by the root cause analysis engine can be provided in exchange for a fee.

This application claims the benefit of priority to U.S. provisional application 61/653,641 filed May 31, 2013, and U.S. provisional application 61/661,014 filed Jun. 18, 2013. These and all other extrinsic materials discussed herein are incorporated by reference in their entirety.

### FIELD OF THE INVENTION

The field of the invention is root cause analysis technologies.

### BACKGROUND

Digital content, especially user generated content, continues to grow at an ever increasing pace. Users are deluged with massive amounts of content and find it impossible to read or assimilate the content quickly. For example, when a celebrity posts content on Facebook®, it is entirely possible that user generated comments posted in response to the posted content can number in the tens of thousands, which is completely beyond the scope of a user to assimilate. Another example includes user-generated reviews associated with products on Amazon®. Fortunately, Amazon distills the product reviews based on a reviewer-assigned scale from 1 to 5 stars, which allows a user to quickly understand how the reviewers in aggregate view the product. Unfortunately, Amazon or other such content-aggregating sites fail to provide a reason “why” individuals feel (i.e., have a sentiment) the way they do about a topic. Further, no known mechanism exists to allow users to drill down on a root cause for the individuals' sentiments.

Others have put forth effort toward generating sentiment. For example, U.S. patent application publication 2011/0208522 to Pereg et al. titled “Method and Apparatus for Detection of Sentiment in Automated Transcriptions”, filed Feb. 21, 2010, describes detecting a sentiment based on training samples and information tagging. Pereg makes passing references to conducting root cause analysis with respect to revealing a reason or cause for a problem or an event exhibited in one or more problems, but fails to appreciate that a root cause of a sentiment provides valuable insight to a user when a person is reviewing aggregated user-generated content. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Thus, there is still a need for methods of providing access to root causes analysis for sentiment or other concepts to users.

### SUMMARY OF THE INVENTION

The inventive subject matter provides apparatus, systems and methods in which one can obtain a root cause analysis of a sentiment related to one or more documents. One aspect of the inventive subject matter includes a method of generating a root cause with respect to a sentiment. Contemplated methods include providing access to or configuring a device to operate as a root cause analysis engine preferably capable of generating one or more root causes associated with a sentiment. The method further includes presenting an interface, possibly an icon on a web page, through which one or more users are able to initiate a root cause analysis with respect to the sentiment. Contemplated methods also include obtaining one or more sentiments representative of opinions (e.g., positive, negative, neutral, etc.) associated with a topic and related to a corpus of documents. Example documents could include product reviews as can be found on Amazon®, articles, videos, audio, or other types of documents. The root causes analysis engine can analyze the sentiment as a function of the content within the corpus of documents to generate one or more root causes that appear to be drivers for the sentiment. Example root causes can include one or more words, terms, clusters of terms, concepts, or other quantifiable document features. The method also includes configuring an output device to present the root causes to the user.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a sentiment root cause analysis system.

FIG. 2 is a schematic of method of generating a root cause with respect to a sentiment.

### DETAILED DESCRIPTION

It should be noted that while the following description is drawn to a computer/server-based root cause analysis system, various alternative configurations are also deemed suitable and may employ various computing devices including servers, interfaces, systems, databases, agents, peers, engines, controllers, or other types of computing devices operating individually or collectively. One should appreciate such terms are deemed to represent computing devices that comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet-switched network.

One should appreciate that the disclosed techniques provide many advantageous technical effects including generating one or more digital signals representative of a sentiment's root cause. The root cause signals can then be used to configure output devices to render a root cause for user consumption.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of networking, the terms “coupled to” and “coupled with” are also used euphemistically to mean “communicatively coupled with” where to networked elements are able to exchange data possibly via one or more intermediary devices.

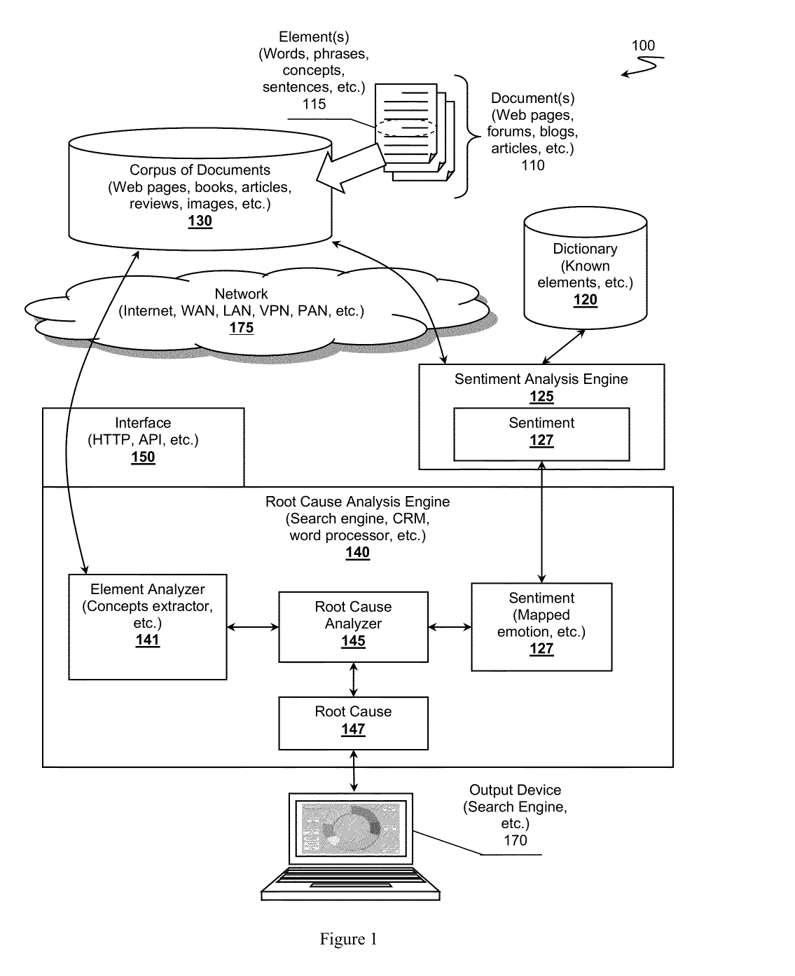

FIG. 1 illustrates an ecosystem that operates as root cause analysis system 100. Root cause analysis system 100 preferably operates to find one or more root causes 147 for sentiment 127 or concept related to a topic in one or more documents 110. In the example shown, root cause analysis system 100 comprises root cause analysis engine 140 and corpus 130 of documents 110.

Corpus 130 can include a compilation of one or more documents 110, possibly of different types, related to a topic on which a sentiment analysis is run. Examples of documents 110 preferably include digital documents comprising text. However, all digital documents are contemplated. For example, audio documents, image documents, video documents, or other types of documents 110 can have their content converted to an appropriate modality for analysis. Image documents can be preprocessed by optical character recognition algorithms (OCR) to derive text, while audio documents can be preprocessed by automatic speech recognition algorithm (ASR) to derive words within the documents. Video documents could be preprocessed by both OCR and ASR to generate content within such documents. The analysis discussed below can then be run based on the derived text or content from the documents.

Corpus 130 could include a document database of searchable records. For example, corpus 130 could be part of a search engine infrastructure storing web pages, or simply storing links to web pages. In other embodiments, corpus 130 of documents could include a compilation of analyzable records; a Customer Relationship Management (CRM) system, electronic medical records (EMR) database, newspaper or magazine articles, text books, scientific papers, file system, peer-reviewed papers, product reviews, or other compilations.

Documents 110 in corpus 130 could comprise a homogenous or a heterogeneous mix of documents. For example, corpus 130 could simply include a homogenous set of on-line forum postings about a single topic, or review postings related of a product on a vendor website (e.g., possibly from Amazon® product review pages). Alternatively, documents 110 could include a heterogeneous mix of data types including text data, audio data, video data, image data, metadata, or other types or modalities of data. One should appreciate that each modality of data can be converted to other modalities if required as alluded to above. For example, audio data can be converted to text via ASR, or image data can be converted to a context or normalized concept represented as text based at least in part on OCR. Example techniques that can be suitability adapted for use in establishing a normalized concept are described in U.S. Pat. No. 8,315,849 to Gattani et al. titled “Selecting Terms in a Document” filed Apr. 9, 2010. In more preferred embodiments, corpus 130 has some form of unifying theme, possibly a specific topic, where corpus 130 can be constructed from a larger document database and where documents 110 are segregated according to normalized concepts or topics. Thus, corpus 130 can be considered, in some embodiments, a theme-specific corpus. Example documents 110 can include reviews, blogs, articles, books, emails, magazines, newspapers, news stories, financial articles, forum post, financial posts, political writing, advertisements, or other types of documents.

Document 110 can be considered an encoding of information that is preferably available in a digital format (e.g., text, audio, image, video, metadata, etc.). Documents 110 preferably comprise one or more document elements 115 representing actual information on which a sentiment analysis is based. Elements 115 of the document 110 can cover a broad spectrum of granularity. For example, an element 115 could include a single word in the document 110 or include a phrase, a sentence, a paragraph, or even the whole document. Further, elements 115 could include derived elements obtained by analyzing the document 110. A derived element could include a normalized concept or a context generated through analyzing content of a corresponding document 110 as referenced above. Example elements 115 include a word, an idiom, a phrase, a concept, a normalized concept, a language independent element, an item of metadata, or other quanta of information.

Root cause analysis engine 140 couples with corpus 130 of documents via one or more document interfaces 150, possibly operating via a web service (e.g., HTTP server, API, etc.). Interface 150 could include a query-based interface capable of accepting natural language queries or structured database queries. In some embodiments, interface 150 could simply include a file system interface through which documents 110 can be accessed on a computer system's storage device (e.g., hard drive, SSD, flash, RAID, NAS, SAN, etc.). Other example interfaces 150 that can be leveraged by root cause analysis engine 140 include a web site, a web page, an application program interface (API), a database interface, a mobile device, a tablet, a phablet, a smart phone, a search engine, a web crawler, a browser, or other type of interface through which analysis engine 140 can obtain information related to documents 110. For example, root cause analysis engine 140 could obtain document information as a CSV file, XML, HTML, rich text, JPEG, or other format from a document database.

Root cause analysis engine 140 is illustrated as a standalone server. However, it should be appreciated that its roles or responsibilities can be placed on any one or more computing devices with sufficient capability to manage the root cause analysis responsibilities. In some embodiments, root cause analysis engine 140 operates as a for-fee Internet-based service, possibly on a cloud-based server farm where it can offer its root-causes analysis services as a platform-as-a-service (PaaS), an infrastructure-as-a-service (IaaS), or a software-as-a-service (SaaS). In other embodiments, it can be distributed across one or more computing devices; a cell phone and computer for example. Regardless of the implementation of analysis engine 140, it is preferably configured to obtain information related to corpus 130 of documents.

One specific piece of information obtained by analysis engine 140 preferably includes sentiment 127 related to corpus 130 or documents 110. In the example shown, analysis engine 140 obtains sentiment 127 from sentiment analysis engine 125, which derives sentiment 127. Sentiment 127 can be derived according to one or more known techniques, or based on techniques yet to be discovered. One among many possible sentiment analysis techniques that could be suitably adapted for use includes those described in U.S. Pat. No. 8,041,669 to Nigam et al. titled “Topical Sentiments in Electronic Stored Communications”, filed on Dec. 15, 2010. Another example includes U.S. Pat. No. 8,396,820 to Rennie titled “Framework for generating sentiment data for electronic content”, filed Apr. 28, 2010. Still another example includes U.S. Pat. No. 8,166,032 to Sommer et al. titled “System and Method for Sentiment-based Text Classification and Relevancy Ranking”, filed Apr. 9, 2009. With respect to stock market, yet another example includes U.S. Pat. No. 7,966,241 to Nosegbe titled “Stock Method for Measuring and Assigning Precise Meaning to Market Sentiment”, filed Mar. 1, 2007. Yet further U.S. Pat. No. 7,930,302 to Bandaru et al. titled “Method and System for Analyzing User-Generated Content” filed Nov. 5, 2007 also discloses suitable techniques that can be leveraged for use with the inventive subject matter.

One should appreciate that sentiment 127 can be derived from corpus 130, elements 115, and documents 110 through numerous techniques. Thus, the inventive subject matter is considered to include selecting a sentiment analysis rules set based on elements 115. For example, should elements 115 include references to food or include an image that is recognized as related to food, sentiment analysis engine 125 can select a sentiment analysis rules set that would be more suitable for determining sentiment with respect to the concept or topic of “food”, possibly the algorithm discussed by Bandaru in U.S. Pat. No. 7,930,302.

Further, sentiment 127 can be associated with different objects in the system at different levels of granularity: a single element 115 in document 110, a document 110, across a plurality of documents, the corpus 130, or other association. In more preferred embodiments, sentiment 127 is at least associated with a topic (e.g., product, political view, stock, review, forum thread, etc.). Sentiment 127 can be represented as a value indicating positive sentiment, negative sentiment, neutral sentiment, or other values. For example, a single sentence in document 110 could be identified as having a positive sentiment by assigning the sentence a value of +3 based on analysis of elements 115 in the sentence, where another sentence might have a negative sentiment with a value of −1 based on the analysis of elements 115 in the second sentence. If the document only has the two sentences, the document sentiment could be the sum of sentence sentiments; +2 in for this example. One should keep in mind that such sentiments could relate to one or more specific concepts or topics. One should appreciate the inventive subject matter can include multiple scales or range of values to represent sentiment. All possible sentiment values are contemplated.

In some embodiments, sentiment 127 can be derived through the use of dictionary 120 of known elements, where each known element comprises a mapping or weighting to sentiment 127. Further, each known element can include a weighting that represents a possible contribution of the known element to a final sentiment value. For example in the case of an element 115 representing a word (i.e., elements 115 has a granularity of a word), the known element word “love” might have a high positive weight, while the known element word “like” might have a lower positive weight. Thus, each element 115 can be mapped, along with a weight if desired, to at least one of a positive sentiment value, negative sentiment value, or even a neutral sentiment value. In some embodiments, element 115 could represent a positive sentiment as well as a negative sentiment value depending on the associated context, concept, user, or other factors. For example, element 115 might have a positive sentiment value of +1 for a specific concept or topic and have a negative value of −1 for a different specific concept or topic. Other weighting values are also possible. For example, an exceptional word (e.g., a known element that has very rare frequency of use) could have a much greater magnitude, or neutral words could have a weight of 0. Although sentiment values include positive, negative, or neutral aspects, one should appreciate that the inventive subject matter includes other sentiment value types. Example additional sentiment types could include emotionality, subtlety, persuasiveness, obfuscation, nostalgia, or other types of sentiment.

Elements 115 can also map to concepts as previously discussed. In such cases, concepts can be mapped to sentiment values. Further, root causes 147 can comprise a mapping between derived concepts from corpus 130 and elements 115 within the corpus to sentiment values. Thus, the concepts within documents 110, sentiment 127, and root cause 147 can be considered a foundational triad from which numerous advantages flow as discussed below. An especially preferred mapping includes mapping root cause 147 to one or more emotions associated with the documents. In the example shown, sentiment 127 is represented as being mapped to an emotion. Sentiment 127 can be mapped to an emotion through various techniques. In some embodiments, sentiment 127 can include multiple values, possibly stored as a vector, where each value represents a possible dimension of the corresponding sentiment 127. A vector of values can be compared to known emotion signatures defined within a common attribute space. If the vector of values is substantially close to a known emotional signature of corresponding structure, then sentiment 127 can be considered to reflect the corresponding emotion. Such an approach is considered advantageous because it allows one to understand the nature of sentiment 127 and allows one to further differentiate possible drivers. For example, several individuals might have strong positive sentiment toward a topic or concept, say investing. A first person might have strong feelings of love for the hobby of investing while a second person might have strong feelings of greed for money. Although both people give rise to high positive sentiment, their emotional states are quite different, which could result in different root causes 147 for the concept of investing as related to corpus 130.

Interestingly, dictionary 120 of known elements can be considered dynamic in the sense that the weights of the known elements can change with time or with other factors. As time changes, use of a phrase or idiom might change, thus causing the weight of the associated known element to change. Further, the weight might reflect different cultural views, geographical regions, demographics, type of sentiment analysis, or other factors. The dynamic nature of dictionary 120 allows for providing one or more dictionaries, possibly for a fee, that have been adapted to reflect a perspective of interest. Further, offering access to different dictionaries 120 also provides for validating a sentiment from different perspectives. For example, a sentiment standards body that establishes how standards for generating sentiments their root causes could construct or maintain a reference dictionary through which various sentiment analysis providers can objectively validate or at least certify their sentiment analysis systems.

In view that sentiment 127 can be applied to more than one document 110, sentiment 127 could include an aggregate sentiment that includes a compilation of multiple sentiments across one or more documents 110. Further, sentiment 127 can include a plurality of sentiment values. Each value in sentiment 127 could represent a different facet or dimension of sentiment 127. In some embodiments, the sentiment values could include an average sentiment value, a distribution of sentiment values, a confidence level, or other statistical factors. Such an approach is considered advantageous when multiple sentiment analysis techniques can be run on documents 110 in corpus 130, or where a single technique is run but operates according to different policies or rules (e.g., cultural rule sets, demographic rule sets, etc.). The sentiment values can also reflect different sentiment dimensions that can impact sentiment 127. Example dimensions include demographic of a document user, demographic of a document provider, one or more topics in the documents, language, jurisdiction, culture, or other factors. Thus, one should appreciate that portions of corpus 130 can be analyzed based on various dimensions or selection criteria that results in sentiment 127 comprising a multi-valued sentiment.

Root cause analysis engine 140 is preferably configured to analyze elements 115 in corpus 130 with respect to sentiment 127 to generate at least one root cause 147 for sentiment 127. One should appreciate that root cause 147, and sentiment 127 for that matter, can be considered distinct manageable objects within the system, but could be related or linked together. Through comparing elements 115, possibly at different levels of granularity, to sentiments 127, root cause analysis engine 140 provides a view into causes, reasons, or drivers that appear to motivate sentiment 127. Root cause 147 provides valuable insight to those individuals that manage the topics associated with corpus 130. For example, a company marketing a product can determine what factors appear to be sentiment drivers for their products based on product reviews from Amazon or other vendor sites.

Root cause 147 can take on many different forms. In some embodiments, one or more of root cause 147 is associated with each sentiment value to allow users to see what gave rise to the specific sentiment 127. Therefore, in multi-valued sentiments, each sentiment value might have its own root cause 147 or even multiple root causes.

In the example shown, elements analyzer 141 represents a module within root cause analysis engine 140 and is configured or programmed to analyze elements 115 within corpus 130. Element analyzer 141 includes one or more rules sets that relate to the same topic as corpus 130 where the rules sets can govern how analyzer 141 indirectly extracts concepts from documents 110 within corpus 130. For example, a rules set can be related to the topic of banks Analyzer 141 obtains the bank rule rules set and can apply the bank analysis rule sets to bank related corpus 130. The bank rules set can identify elements 115 that relate directly to a bank, or even a specific bank. Then, possibly based on a proximity analysis, analyzer 141 can identify concepts relating the bank's other services perhaps including fees, interest rates, employees, loans, lines of credit, or other concepts. If the same analysis were applied to a different bank, the results of extracted concepts would likely be different because the different bank would have a different corpus 130. One example technique for classifying concepts based on words that could suitably be adapted for use with the inventive subject matter includes U.S. Pat. No. 6,487,545 to Wical titled “Methods and Apparatus for Classifying Terminology Utilizing a Knowledge Catalog”, filed May 28, 1999.

Root cause (RC) analyzer 145 is also considered a module within root cause analysis engine 140 and is configured or programmed to take sentiment 127 and results from element analyzer 141 to determine root cause 147. RC analyzer 145 maps concepts from element analyzer 141 to one or more of sentiment 127 according to a root cause model. One should appreciate that RC analyzer 145 can also function according to multiple root cause models, even root cause models that are concept-specific or topic-specific. For example, when corpus 130 is associated with video game reviews, element analyzer 141 might function according a video game rules set that seeks to generate one or more video game concepts (e.g., character, story, genre, etc.). RC analyzer can then apply one or more video game root cause models, possibly models that are specific to the concepts, to determine what gave rise to sentiment 127. A more specific example might include a root cause model comprising a concept-specific look-up table that cross references elements 115 (e.g., a first index in a matrix) to sentiment 127 (e.g., a second index in the matrix) where the corresponding cell indicates a possible an a priori defined root cause. The root cause model could include multiple concept-specific look-up tables. All possible root cause models are contemplated.

Another acceptable technique for determining root cause 147 could include extracting information from corpus 130 based on a root cause model, and without regard to known words in corpus 130 or predefined features related to sentiment 127. The extracted information can then be used to determine which elements 115 from corpus 130 could have given rise to the sentiment 127. Such an approach is considered advantageous as it is considered to remove bias in determining why sentiment 127 was generated. In some embodiments, root cause 147 can be determined based on one or more root cause models applied to the corpus. For example, root cause engine 140 can search corpus 130 for elements 115 based on one or more algorithms, formulas, or patterns pertaining to a specific model. Root cause engine 140 could search corpus 130 for sentences having defined sentence structures according to the model. When sentences of interest are found, the features of the sentences (e.g., words, phrases, subject, verb, adjectives, adverbs, objects, etc.) can be further extracted and reviewed as indicated by element analyzer 141, which yields extracted concepts. One should appreciate that the sentence features can have multiple levels of granularity; phrase level, term level, word level, or other element level, for example. Root cause engine 140 can then apply one or more decision rules to the features to determine if the feature could represent root cause 147 according to the root cause model. The root cause model approach allows for the root cause engine to generate different types of root causes 147 by providing for variation in the model's algorithms, or variation in decision rules.

An astute reader will recognize that the root cause analysis can be decoupled from the sentiment analysis used to generate sentiment 127. Such an approach gives rise to providing a third party measure or validity of a sentiment analysis. Further, multiple root cause analyses operating based on different algorithms as intimated above can be conducted on a single sentiment 127 to provide better insight into the validity of sentiment 127. In a similar vein, root cause 147 can also include a confidence score associated with the root cause 147 where the confidence score could represent a statistical measure, error analysis, or other factors. Still further, the confidence score could also comprise a validity measure indicating how appropriately root cause 147 represents a sentiment driver for sentiment 127. For example, in an embodiment where the root causes analysis engine operates as a service (e.g., IaaS, SaaS, PaaS, etc.), periodically the service can submit a validity survey to third party individuals. The individuals can then rate the validity of the root cause analysis with respect to sentiment 127. Amazon's Mechanical Turk engine (see URL www.mturk.com/mturk/welcome) or Survey Monkey (see URL www.surveymonkey.com) could be adapted for such a use. The surveys can be constructed according to one or more root cause models as desired.

Root cause 147 of sentiment 127 can cover a broad spectrum of sentiment drivers. In some embodiments, root cause 147 comprises an indication of which element 115 in document 110 corresponds to a sentiment driver. For example, a sentence in document 110 might have a positive sentiment because the known element word “exquisite” is present in the sentence and is associated with a target topic of the sentence (e.g., noun, subject, direct object, indirect object, etc.). It is also contemplated that multiple root causes 147 can combine together in aggregate to form a sentiment driver. For example, root cause 147 could be attributed to a concordance of words in the documents 110 where each word has an associated frequency of appearance. The concordance in aggregate could be considered to have a sentiment signature or emotion signature that could be considered a sentiment driver. Other example root causes 147 can be based on a cluster of elements, a grouping of elements, a trend in drivers, a change in a sentiment metric, a ranking, a vector, an event, a concept, a cloud, a person, a demographic, a psychographic, or other factors.

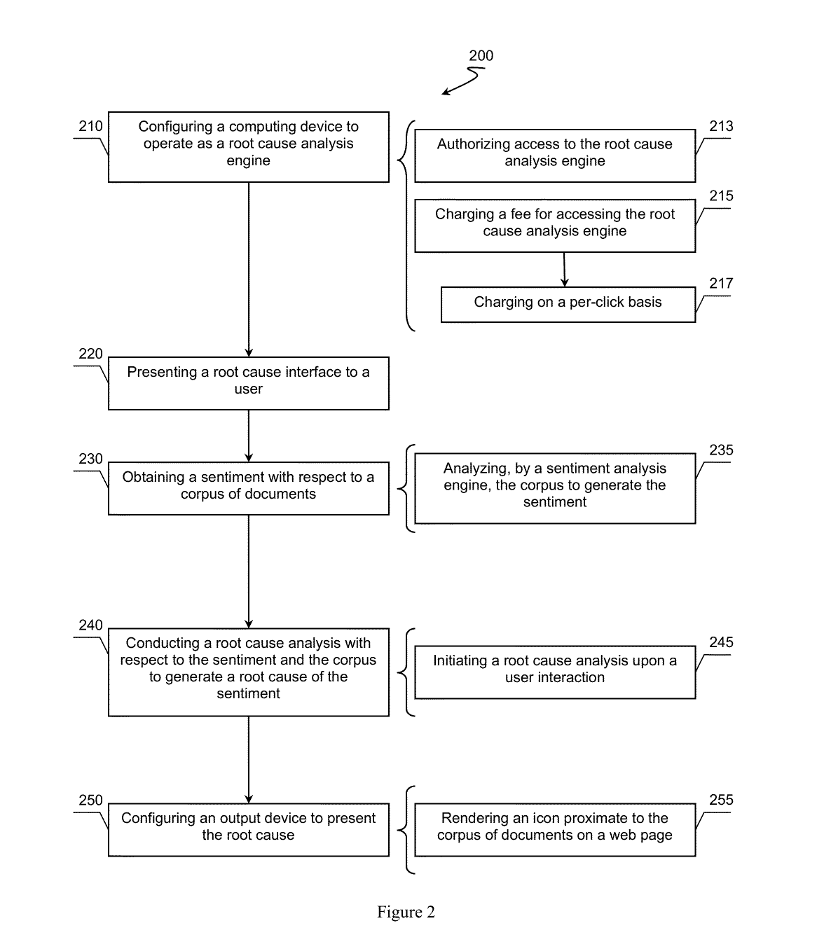

FIG. 2 presents method 200 of generating a root cause, preferably with respect to a sentiment. Beginning with step 210, method 200 includes providing access to a root cause analysis engine. Providing access to the root cause analysis engine can take on many different forms depending on the nature of the corresponding computing device. In some embodiments, one or more users can gain access to the root cause analysis engine operating on a web services platform (e.g., HTTP server, cloud, etc.) via a browser interface. In other embodiments, users can gain access to the root cause analysis engine by configuring or installing one or more applications in a memory of their personal computing device, possibly within their personal area network. For example, a user could install a root cause analysis app on their cell phone where the app configures the cell phone to analyze social media content from the user's favorite social networking sites (e.g., Facebook®, Twitter®, LinkedIn®, etc.) and to generate a root cause for the sentiments of the social media content.

In embodiments where access to the root cause analysis engine is restricted, step 213 can include authorizing access to the engine. Access can be authorized through use of password-user names pairs, account logons via third parties (e.g., social media, sites, etc.), access services (e.g., RADIUS, Kerberos, etc.), or other techniques. Authorizing access is considered advantageous in embodiments where users wish to monetize root cause information. For example, a user might include a product or brand manager. The brand manager could create an account with an entity hosting the root cause analysis engine and then provide advertisements with respect to root causes that favor their brands.

One should appreciate that the root cause analysis engine can operate as a for-fee service and could be located remotely from the web site. Users, or even web services hosting the reviews, could access the services offered by the root cause analysis engine in exchange for a fee assuming proper authentication or authorization. Example fees can include a per-click charge, a flat fee, a per use fee, a charge for a number of uses, a subscription, or other types of fees. Still further, a user is considered to include an entity capable of interacting with the analysis engine; an end user, a manager, an administrator, a human, another computing device, or a database for example.

In view that the root cause analysis engine provides root cause management services to interested entities, step 215 can include charging a fee for accessing the root cause analysis engine. Referring back to the brand manager, the brand manger might use the analysis engine to monitor root cause of sentiment with respect to their brand. The engine hosting entity can allow the brand manager to place advertisements in web pages that appear to have a sentiment aligned with an indicated root cause. Should an end user click through the advertisement, the entity can charge the brand manager a fee in exchange for placing the advertisement. Thus, the entity can charge on a per-click basis as suggested by step 217 as a fee for providing access to the engine.

Step 220 includes presenting a root cause interface to a user where the root cause interface can be configured to initiate a root cause analysis upon a user interaction(see discussion with respect to step 245 below). The root cause interface can include a manager interface through which a manager can construct root cause-based content management programs. Once a desired program is in place, the manager can cause analysis to begin. The root cause interface could also include an end user interface (e.g., browser, HTTP server, etc.) through which an end user can interact with content objects instantiated as a function of root causes (e.g., advertisements, icons, games, etc.). Thus, one can consider the root cause-based instantiated objects as rendered interfaces.

The reader is reminded that a root cause analysis engine is configured to analyze sentiment with respect to a corpus of documents relating to one or more topics as discussed above. For example, the root cause analysis engine can extract, cluster, group, rank, visualize, or otherwise manage root causes where each root cause can be considered a distinct manageable object within the contemplated ecosystem. A root cause can be considered to represent a reason “why” or a driver of sentiment causing the sentiment to take a positive value, negative value, a neutral value, or other a value. One should appreciate that a root cause reflects one or more underlying algorithms used to generate the sentiment.

Step 230 can include obtaining a sentiment with respect to a corpus of documents. The sentiment can be a priori derived or can be generated in real-time as required by a stakeholder. Further, the sentiment can be associated with a single document, multiple documents, or other elements that compose the documents. As suggested by step 235, a sentiment analysis engine analyzes the corpus of documents to generate the sentiment as discussed above.

The corpus of documents can take on many different forms. In some embodiments, the corpus relates to a topic; a product, goods, or services for example. The corpus could include a compilation of text documents representing product reviews, video files, audio files, or other modality of data. Consider a scenario of a web site hosting thousands of user-generated product reviews. The products reviews form a corpus of documents that can be analyzed to determine the root cause for the review sentiments based on the content within the reviews. Although the following discussion presents the inventive subject matter within the context of the product reviews as a corpus of documents, one should appreciate that inventive subject matter is considered applicable to all manner of documents.

Step 240 includes conducting, by the root cause analysis engine, the root cause analysis with respect to the sentiment and the corpus to generate the root cause of the sentiment. The root cause analysis engine can perform the root cause analysis according to many different techniques as discussed above. The root causes analysis includes determining drivers for the sentiments by clustering, grouping, or ranking root cause results. For example, the root cause analysis engine can compile a statistical clustering of terms in a sentiment dictionary (e.g., words, phrases, concepts, etc.) used in the reviews where the terms are considered drivers for sentiment. Such an approach is considered advantageous when each document in a corpus (i.e., the reviews) could have its own drivers for sentiment. Thus, the root causes can include a statistical compilation of drivers for the sentiment. One should appreciate that the root causes can be differentiated according to one or more attributes of the documents in the corpus. For example, the root cause can be different based on the demographics of the author, the time of document creation, or other factors.

The analysis of the root cause can be initiated upon detecting a user interaction as suggested by step 245. Root cause analysis can be initiated based on instructions from a manager through the root cause analysis engine management interface. Alternatively, and more preferably, the analysis is initiated in real-time with respect to an end user engaging in content created by others, possibly via a social media site. As the user begins to access the user-generated content, the root cause analysis engine can initiate analysis of the user-generated content (e.g., product reviews, comments, blogs, etc.). In some scenarios, the engine might have already derived sentiment related to topics within the content. The engine can further analyze the user-generated content and sentiment to generate the root cause, which can then be leveraged by hosting site to present other content (e.g., promotions, games, advertisements, etc.).

Within a product review web site example, the web site can provide a root cause interface, preferably in the form of an icon, proximate to the reviews where the root cause interface allows a user to initiate a root cause analysis of the reviews. Other example interfaces can include a browser, a search engine, an applet, an application, an application program interface (API), or other type of accessible interfaces. Possibly in real-time, a user has an interaction with the root cause interface to cause the root cause analysis engine to begin its analysis. In some embodiments, the root cause analysis engine obtains a sentiment derived from the reviews. For example, the sentiment could be derived by the root cause analysis engine or obtained from a third party sentiment analysis engine. Regardless of the source of the sentiment, the root cause analysis engine can determine one or more drivers (i.e., the reason “why”) for the sentiment in the reviews. When the user clicks on the root cause icon, the root cause analysis engine can begin its analysis on the reviews, or portions of the reviews. Further, the root cause analysis engine can cause the web site, or other output device, to present the root causes of the sentiment in the reviews.

The root cause analysis engine can prepare the root causes for visualization as desired by configuring an output device to present the root cause to a user as indicated by step 250. In some embodiments, the analysis engine can generate HTML, XML, javascript, or other types of instructions that configure a browser to render, or otherwise present, the root cause to the user. For example, when a user clicks on the root cause icon near the product reviews of interest as suggested by step 255, the user can be automatically presented with a graphical display showing the sentiment along with the root causes or other drivers for the sentiment. Example output devices can include the third party web server hosting the corpus, a search engine, a cell phone, a browser-enabled computer, a printer, a database, mobile devices, personal area network devices, vehicles, kiosks, appliances, or other type of device. Additional information can also be presented including metrics, number of documents analyzed, demographic information, review percentages, root cause trends, concept maps, or other information.

An astute reader will appreciate that the root cause analysis can be considered orthogonal to the sentiment analysis. For example, once the root cause analysis engine obtains a sentiment with respect to the corpus of document, the analysis engine can attempt to map positive or negative concepts to the sentiment. Such concepts might be generated based on keywords corresponding to “positive” words, “negative” words, or even “neutral” words with respect to one aspect of the corpus. Such an approach allows for decoupling the root cause analysis from the sentiment algorithm and gives rise to validating such sentiments.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of generating a root cause, the method comprising:
configuring a computing device to operate as a root cause analysis engine;
presenting a root cause interface to a user, the root cause interface configured to initiate a root cause analysis upon user interaction;
obtaining a sentiment with respect to a corpus of documents;
conducting, by the root cause analysis engine, the root cause analysis with respect to sentiment and the corpus to generate a root cause of the sentiment; and
configuring, by the root cause analysis engine, an output device to present the root cause to the user.

2. The method of claim 1, wherein the step of providing access to the root cause analysis engine includes authorizing access to the root cause analysis engine.

3. The method of claim 1, wherein the step of providing access to a root cause analysis engine includes charging a fee for accessing the root cause analysis engine.

4. The method of claim 3, wherein the step of charging a fee for accessing the root cause analysis engine includes a charging on a per-click basis.

5. The method of claim 3, wherein the fee comprises at least one of the following: a subscription, a click through fee, a flat charge, and a charge for a number of interactions.

6. The method of claim 1, wherein the step of presenting the root cause interface includes rendering an icon proximate to the corpus of documents on a web page.

7. The method of claim 1, wherein the corpus of documents comprises at least one of the following: a collection of forum posts, a collection of product reviews, a collection of text documents, a collection of audio documents, a collection of video documents, a collection of image documents, and a collection of articles.

8. The method of claim 1, wherein the wherein the step of obtaining the sentiment includes a sentiment analysis engine analyzing the corpus of documents to generate the sentiment.

9. The method of claim 8, wherein the step of analyzing the corpus of documents to generate the sentiment occurs substantially in real-time upon the user interacting with the root cause interface.

10. The method of claim 1, wherein the step analyzing the root cause with respect to sentiment occurs substantially in real-time upon the user interacting with the root cause interface.

11. The method of claim 1, wherein the user includes at least one of the following: an end-user, a human user, and a computing device.

12. The method of claim 1, wherein the root cause interface comprises at least one of the following: an icon, a browser, a search engine, an applet, an application, and an application program interface.

13. The method of claim 1, wherein the output device comprises at least one of the following: a third party web server, a search engine, a cell phone, a browser-enabled computer, a mobile device, a wearable device, and a printer.
